(19) United States
(12) Patent Application Publication
(10) Pub. No.: US 2010/0014125 A1
(43) Pub. Date: Jan. 21, 2010

(54) Image Display Device with Scanning Function

(75) Inventors: Ren-Wu Gong, Hsinchu (TW); Pao-Ming Chi, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/270,061

(22) Filed: Nov. 13, 2008

(30) Foreign Application Priority Data
Jul. 17, 2008 (CN) 200810135860.0

(51) Int. Cl. H04N 1/04

(52) U.S. Cl. 358/474

(57) ABSTRACT

An image display device includes a main body, a display screen, a scanning module, and an object displacement unit. The main body has a first surface and a second surface. The display screen is arranged on the first surface of the main body for displaying an image of an object. The scanning module is disposed within the main body and disposed in the vicinity of the bottom of the main body, thereby obtaining an image data. The object displacement unit is disposed within the main body and includes an object inlet and an object outlet. The object inlet and the object outlet are formed in the first and second surfaces of the main body, respectively. The cross-section area of the object inlet is greater than that of the object outlet. The object is transported from the object inlet to the object outlet when the object is scanned by the scanning module.

### FIELD OF THE INVENTION

The present invention relates to an image display device with a scanning function, and more particularly to an image display device for scanning an image of an object and displaying the image of the object.

### BACKGROUND OF THE INVENTION

With increasing development of digitalized generation, digital cameras have gradually replaced conventional cameras for capturing photos, pictures or documents. For example, after an image of a photo is captured, the image is converted into an electronic file for facilitating storage. Since the image of the photo is stored as the electronic file, digital photo frame for displaying the digital photo is now rapidly gaining in popularity.

On the other hand, for converting the paper-type photos into electronic files and viewing the digital photos via a digital photo frame, a series of procedures are required. Firstly, a scanner is used to scan the paper-type photos into electronic files. Then, the digital photo frame is connected to the computer via a USB connecting line. After the electronic files of these photos are transmitted to the digital photo frame through the computer, the digital photos can be displayed on the digital photo frame. This conventional image displaying method needs a scanner, a computer and one or two USB connecting lines. In addition, since the scanner driver, the scanning application program and the digital photo frame should be installed and operated by the user, the complicated processes are troublesome and not user-friendly.

FIG. 1A is a schematic front perspective view illustrating a digital photo frame with a scanning function that is disclosed in U.S. Pat. No. 7,019,871 B2. FIG. 1B is a schematic rear perspective view of the digital photo frame shown in FIG. 1A. Please refer to FIGS. 1A and 1B. The digital photo frame principally comprises a frame 10, a scanner housing 11 and a computer housing 12. A display screen 100 is mounted on the frame 10 for displaying a digital image thereon. The scanner housing 11 is coupled to the frame 10. A scanner (not shown) is disposed within the scanner housing 11 for scanning at least one photo. The computer housing 12 houses various electronic components (not shown) for performing functional operations of digital photo frame 1. These electronic components include for example a microprocessor, a hard disc and a memory. The computer housing 12 is coupled to the scanner housing 11. The computer housing 12 may facilitate supporting the scanner housing 11 and the frame 10 such that the scanner housing 11 and the frame 10 are disposed in upright positions.

The digital photo frame 1 has an object inlet 110 in a lateral surface of the scanner housing 11. For scanning an object such as a photo, a picture or a document, the object is introduced into the object inlet 110 and then scanned by the scanner within the scanner housing 11. The scanned image of the object is converted into an electronic file, which is then stored in or displayed on the digital photo frame 1.

The conventional digital photo frame 1, however, still has some drawbacks. For example, since the object inlet 110 is formed in the lateral surface of the scanner housing 11 (as shown in FIG. 1B), the object such as a photo, a picture or a document should be upright and then aligned with the object inlet 110. Since the photo, the picture or the document is usually made of flexible paper, the photo, the object needs to be held by the user's hand when the object is upright. If the object fails to be precisely aligned with the object inlet 110 or the object is suffered from deformation, the scanning quality is usually deteriorated.

Therefore, there is a need of providing an image display device with a scanning function to obviate the drawbacks encountered from the prior art.

### SUMMARY OF THE INVENTION

The present invention provides an image display device with a scanning function for facilitating ease placement of the object to be scanned, horizontally introducing the object into the image display device, and smoothly transporting the object during the scanning process.

In accordance with an aspect of the present invention, there is provided an image display device with a scanning function for scanning an image of an object and displaying the image of the object. The image display device includes a main body, a display screen, a scanning module, and an object displacement unit. The main body has a first surface and a second surface opposed to the first surface. The display screen is arranged on the first surface of the main body for displaying the image of the object. The scanning module is disposed within the main body and disposed in the vicinity of the bottom of the main body, thereby obtaining an image data. The object displacement unit is disposed within the main body and includes an object inlet and an object outlet. The object inlet is formed in the first surface of the main body. The object outlet is formed in the second surface of the main body. The cross-section area of the object inlet is greater than that of the object outlet. The object is transported from the object inlet to the object outlet when the object is scanned by the scanning module.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic front perspective view illustrating a digital photo frame with a scanning function that is disclosed in U.S. Pat. No. 7,019,871 B2;

FIG. 1B is a schematic rear perspective view of the digital photo frame shown in FIG. 1A;

FIG. 2 is a schematic functional block diagram illustrating a digital photo frame with a scanning function according to a preferred embodiment of the present invention;

FIGS. 3A, 3B and 3C are respectively schematic front, rear and side views of the digital photo frame of the present invention;

FIG. 4A is a schematic cross-sectional view of the object displacement unit;

FIG. 4B is a schematic cross-sectional view illustrating an object to be introduced into the object displacement unit according to a first approach; and

FIG. 4C is a schematic cross-sectional view illustrating an object to be introduced into the object displacement unit according to a second approach.

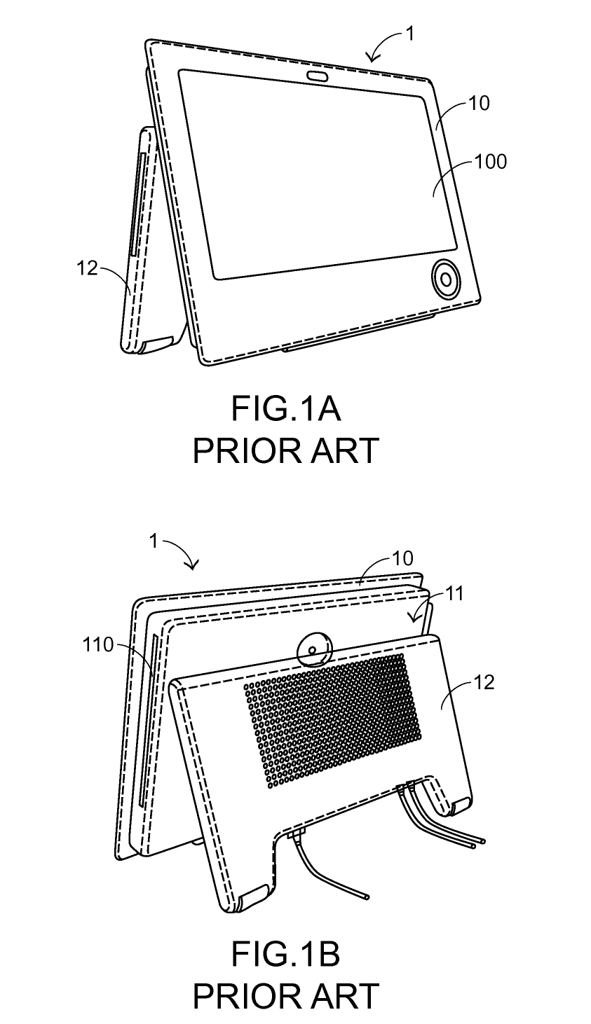

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

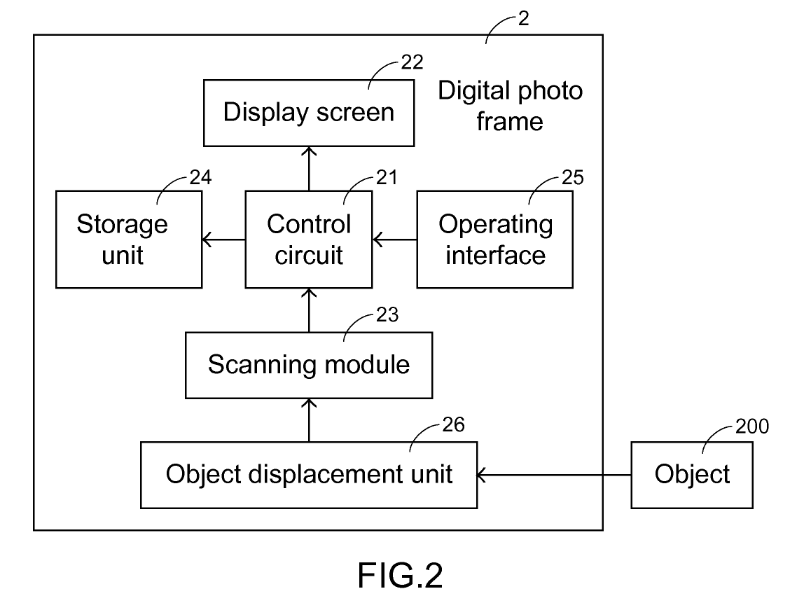

FIG. 2 is schematic functional block diagram illustrating a digital photo frame with a scanning function according to a preferred embodiment of the present invention. The digital photo frame of the present invention is used to scan and display an image of an object 200. As shown in FIG. 2, the digital photo frame 2 principally comprises a control circuit 21, a display screen 22, a scanning module 23, a storage unit 24, an operating interface 25 and an object displacement unit 26.

Hereinafter, the operations of the digital photo frame of the present invention will be illustrated in more details. After the object 200 is placed in the object displacement unit 26, the scanning module 23 scans the image of the object 200 to obtain an image data. The image data that is obtained by using the scanning module 23 to scan the object 200 can be stored in the storage unit 24. The image of the object 200 can be displayed on the display screen 22. When an instruction is inputted via the operating interface 25, the control circuit 21 will execute a corresponding function of powering on/off the digital photo frame 2, activating the scanning function, switching the image display function and the like. The control circuit 21 is electrically connected to the display screen 22, the scanning module 23, the storage unit 24 and the operating interface 25. By the control circuit 21, the image data can be stored in the storage unit 24. In addition, after the image data stored in the storage unit 24 is read out by the control circuit 21, the image data can be transmitted to the display screen 22 for display. Via the operating interface 25, the control circuit 21 can execute corresponding functions.

In the above embodiment, the object 200 is a photo or a picture. An example of the storage unit 24 includes but is not limited to a built-in hard disc, a built-in memory or an external memory card (e.g. a CF memory card, a MS memory card, a SD memory card, a MMC memory card or a XD memory card).

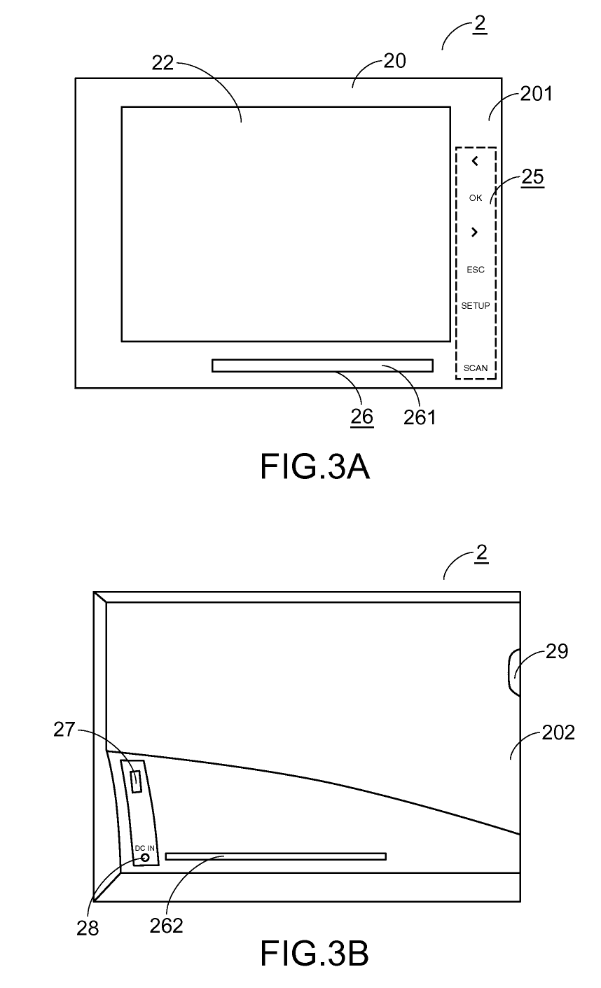

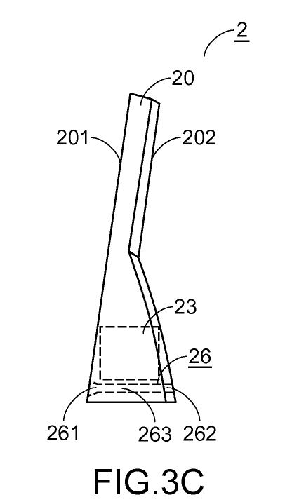

Hereinafter, the configurations of the digital photo frame 2 will be illustrated with reference to FIGS. 3A, 3B and 3C.

FIGS. 3A, 3B and 3C are respectively schematic front, rear and side views of the digital photo frame of the present invention. Please refer to FIGS. 3A, 3B and 3C. The digital photo frame 2 has a main body 20. The main body 20 has a first surface 201 and a second surface 202. The display screen 22 is arranged on the first surface 201 of the main body 20. The scanning module 23 is disposed within the main body 20 and under the display screen 22. The operating interface 25 is also arranged on the first surface 201 of the main body 20. The operating interface 25 comprises multiple function keys including a power switch key, a scanning activation key, an image display switching key, an image mode switching key, and so on. By actuating these function keys, corresponding functions are executed.

In addition, a USB port 27, a power cable insertion hole 28, a memory card insertion slot 29 are formed in the second surface 202 of the main body 20. The object displacement unit 26 runs through the main body 20. The object displacement unit 26 includes an object inlet 261 and an object outlet 262. The object inlet 261 is formed in the first surface 201 of the main body 20. The object outlet 262 is formed in the second surface 202 of the main body 20. The object inlet 261 and the object outlet 262 are arranged at the same level with respect to the main body 20.

In the object displacement unit 26 of the digital photo frame 2 of the present invention, the cross-section area of the object inlet 261 is greater than the cross-section area of the object outlet 262 so as to facilitate smoothly introducing the photo or picture to be scanned into the object inlet 261. Furthermore, the scanning module 23 of the digital photo frame 2 is disposed under the display screen 22. That is, the scanning module 23 is disposed in the vicinity of the bottom of the main body 20. Under this circumstance, the photo or picture to be scanned can be supported by the desk plane and thus smoothly transported through the object displacement unit 26 during the scanning process.

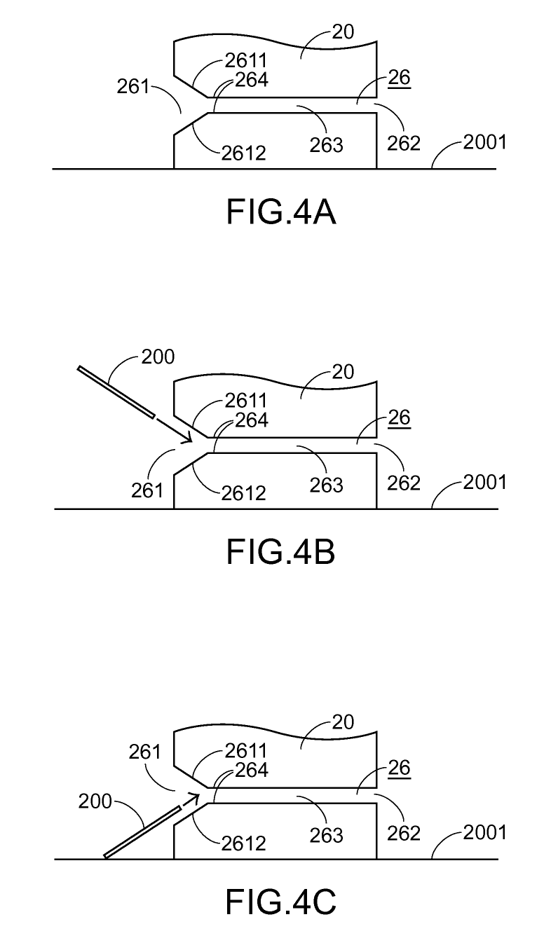

FIG. 4A is a schematic cross-sectional view of the object displacement unit 26. The object displacement unit 26 further comprises a scanning channel 263 and a guide platform 264. The scanning channel 263 is communicated with the object inlet 261 and the object outlet 262. The guide platform 264 is disposed in the vicinity of the upper and lower sides of the object inlet 261 for guiding the object 200 to be horizontally transported through the scanning channel 263.

In this embodiment, the cross-section area of the scanning channel 263 is smaller than the cross-section area of the object inlet 261 but equal to the cross-section area of the object outlet 262. The object inlet 261 is defined by a first slant surface 2611 and a second slant surface 2612. In other words, the object inlet 261 has a funnel profile. For scanning the object 200 (e.g. a photo or picture) by the scanning module 23, the object 200 can be placed in the object displacement unit 26 while conforming to the inclined angles of the slant surfaces 2611 and 2612. Moreover, the guide platform 264 that is disposed in the vicinity of the upper and lower sides of the object inlet 261 is effective for guiding the object 200 to be horizontally transported through the scanning channel 263. As a consequence, the object 200 to be scanned is smoothly transported through the object displacement unit 26 during the scanning process.

FIG. 4B is a schematic cross-sectional view illustrating an object to be introduced into the object displacement unit according to a first approach. The object 200 is introduced into the object inlet 261 while conforming to the inclined angle of the first slant surface 2611. Next, the object 200 is guided by the guide platform 264 that is disposed below the first slant surface 2611 so as to be horizontally transported through the scanning channel 263.

FIG. 4C is a schematic cross-sectional view illustrating an object to be introduced into the object displacement unit according to a second approach. The object 200 is introduced into the object inlet 261 while conforming to the inclined angle of the second slant surface 2612. Next, the object 200 is guided by the guide platform 264 that is disposed above the second slant surface 2612 so as to be horizontally transported through the scanning channel 263.

Furthermore, the inclined angle of the second slant surface 2612 can be selected such that the object 200 is supported by the desk plane 2001. Under this circumstance, the object 200 to be scanned can be more smoothly transported through the object displacement unit 26 during the scanning process.

As previously described, since the object inlet 110 of the conventional digital photo frame 1 is formed in the lateral surface of the scanner housing 11 and the object to be scanned needs to be upright, it is difficult to align the object with the object inlet 110. If the object fails to be precisely aligned with the object inlet 110 or the object is suffered from deformation, the scanning quality is usually deteriorated. In contrast, since the canning module 23 of the digital photo frame 2 of the present invention is disposed within the main body 20, under the display screen 22 and in the vicinity of the bottom of the main body 20, the object 200 to be scanned can be more smoothly transported through the object displacement unit 26 during the scanning process. Due to the slant surfaces 2611 and 2612 of the object inlet 261 and the guide platform 264, the object 200 can be horizontally transported through the scanning channel 263. As a consequence, the scanning quality of the image obtained by the digital photo frame 2 of the present invention is enhanced.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image display device with a scanning function for scanning an image of an object and displaying the image of the object, the image display device comprising:
a main body having a first surface and a second surface opposed to the first surface;
a display screen arranged on the first surface of the main body for displaying the image of the object;
a scanning module disposed within the main body and disposed in the vicinity of the bottom of the main body, thereby obtaining an image data; and
an object displacement unit disposed within the main body and comprising an object inlet and an object outlet, wherein the object inlet is formed in the first surface of the main body, the object outlet is formed in the second surface of the main body that is opposed to the first surface, the cross-section area of the object inlet is greater than that of the object outlet, and the object is transported from the object inlet to the object outlet when the object is scanned by the scanning module.

2. The image display device according to claim 1 further comprising:
a storage unit disposed within the main body for storing the image data therein; and
a control unit disposed within the main body and electrically connected to the display screen for reading out the image data from the storage unit so as to output the image data to the display screen for display.

3. The image display device according to claim 2 further comprising an operating interface disposed within the main body and electrically connected to the control unit, wherein the control unit executes the function of powering on/off the image display device, activating the scanning function or switching the image display function when an instruction is inputted via the operating interface.

4. The image display device according to claim 2 wherein the storage unit is a built-in hard disc, a built-in memory or an external memory card.

5. The image display device according to claim 1 wherein a USB port, a power cable insertion hole, a memory card insertion slot are further formed in the second surface of the main body.

6. The image display device according to claim 1 wherein the object inlet of the object displacement unit is defined by multiple slant surfaces.

7. The image display device according to claim 1 wherein the object displacement unit further comprises a scanning channel that is communicated with the object inlet and the object outlet, and the cross-sectional area of the scanning channel is smaller than the cross-section area of the object inlet but equal to the cross-section area of the object outlet.

8. The image display device according to claim 1 wherein the object is a photo or a picture.

9. The image display device according to claim 1 wherein the image display device is a digital photo frame.

10. The image display device according to claim 1 wherein the object displacement unit further comprises a guide platform, which is disposed in the vicinity of the upper and lower sides of the object inlet, for guiding the object to be horizontally introduced into the object inlet.
